(19) United States
(12) Patent Application Publication
(10) Pub. No.: US 2022/0388087 A1
(43) Pub. Date: Dec. 8, 2022

(54) STUD SUPPLY DEVICE AND STUD SUPPLY METHOD

(71) Applicant: HONDA MOTOR CO., LTD., Minato-ku, Tokyo (JP)

(72) Inventors: Hiroshi Miwa, Haga-gun, Tochigi-ken (JP); Yasushi Iwatani, Haga-gun, Tochigi-ken (JP); Takuya Furuno, Haga-gun, Tochigi-ken (JP); Yuichi Hirata, Haga-gun, Tochigi-ken (JP); Yohei Teragaito, Haga-gun, Tochigi-ken (JP); Tomomi Komuro, Haga-gun, Tochigi-ken (JP)

(21) Appl. No.: 17/776,286

(22) PCT Filed: Sep. 23, 2020
(86) PCT No.: PCT/JP2020/035716

§ 371 Date: May 12, 2022

(30) Foreign Application Priority Data
Nov. 13, 2019 (JP) 2019-205123

(51) Int. Cl. B23K 9/20

(52) U.S. Cl. CPC B23K 9/206

(57) ABSTRACT

Provided are a stud supply device and a stud supply method with which a stud can be supplied to a welding electrode in the correct orientation. The stud supply device comprises: a magazine in which a predetermined number of studs can be aligned and stored in series inside a magazine hole from a stop part to one end side; switching mechanisms having a plurality of balls that can move between a position contacting the studs and a position not contacting the studs, and a reciprocating member that restricts the movement of the plurality of balls, the switching mechanisms switching between a state in which the studs are stopped at the stop part and a state in which the studs are allowed to pass; and a first air injection part that is provided more on the one end side than the stop part, and that injects air from the one end side to the stud stopped at the stop part.

### TECHNICAL FIELD

The present invention relates to a stud supplying device (stud supply device) and a stud supplying method (stud supply method) for supplying studs to be welded onto a workpiece to a welding electrode of a projection welding device.

### BACKGROUND ART

A projection welding device that welds studs onto a workpiece includes a robot that operates a stud gun, and a stud supplying device that supplies the studs to a welding electrode mounted on the stud gun. Such a stud supplying device is disclosed in JP 2014-213380 A. The stud supplying device includes an accommodating pipe a longitudinal direction of which is parallel to a vertical direction, a rod inserted from below into the accommodating pipe, a piston connected to the rod, and a cylinder in which the piston is accommodated. In the accommodating pipe, there are accommodated a plurality of studs that are aligned upward in series with distal ends thereof oriented upward. In such a device, when air is supplied into the cylinder, the piston and the rod are pushed upward, and the group of studs is also pushed upward. Upon being pushed upward, a leading stud is pushed out from an upper end of the accommodating pipe, and is supplied to the welding electrode which is standing by while facing the stud above the accommodating pipe.

### SUMMARY OF THE INVENTION

From the standpoint of operational efficiency, it is preferable for the stud supplying device to be mounted on the stud gun rather than being disposed adjacent to the stud gun. However, in the case that the stud supplying device is mounted on the stud gun, when a plurality of studs are aligned in series inside the accommodating pipe as in JP 2014-213380 A, a problem arises in that the posture of the studs inside the accommodating pipe changes with a change in the posture of the stud gun. For example, in the case that a longitudinal direction of the accommodating pipe is parallel to a horizontal plane, a distal end central portion of the flanged studs is lower than a proximal end central portion of the flanged studs. When the studs are pushed out from the accommodating pipe in such a state, the studs cannot be properly supplied to the welding electrode that is standing by alongside the accommodating pipe.

The present invention has been devised in consideration of such problems, and has the object of providing a stud supplying device and a stud supplying method which are capable of supplying studs to a welding electrode at a correct posture.

A first aspect of the present invention is characterized by a stud supplying device that supplies studs to be welded onto a workpiece to a welding electrode of a projection welding device, the stud supplying device comprising:

a magazine including a magazine hole penetrating therethrough in a direction in which the studs are supplied to the welding electrode, wherein the studs are allowed to be inserted from one end and ejected from another end of the magazine hole, the studs are allowed to be stopped at a stopping member positioned on a side of the other end of the magazine hole, and a predetermined number of the studs are allowed to be accommodated inside the magazine hole in series and in alignment from the stopping member toward a side of the one end;

a switching mechanism including a plurality of movable bodies configured to move between a position in which the movable bodies come into contact with the studs and a position in which the movable bodies do not come into contact with the studs, and a locking member configured to restrict movement of the plurality of movable bodies, the switching mechanism being configured to switch between a state in which the studs are stopped at the stopping member and a state in which the studs are allowed to pass; and

an air injection unit disposed farther on the side of the one end than the stopping member, and configured to inject air from the side of the one end to the studs that are stopped at the stopping member.

A second aspect of the present invention is characterized by a stud supplying method that uses the stud supplying device according to the first aspect to supply the studs to the welding electrode of the projection welding device, the stud supplying method comprising the steps of:

accommodating a first stud and a second stud in this order in the magazine hole;

placing the movable bodies of the first switching mechanism in contact with the first stud and thereby stopping the first stud at the stopping member;

ejecting the first stud by switching a state of the first switching mechanism, while injecting air from the first air injection unit to correct a posture of the first stud that is stopped at the stopping member;

placing the movable bodies of the second switching mechanism in contact with the second stud and thereby stopping the second stud at the standby section; and

after having ejected the first stud, allowing the second stud to move to the stopping member by switching a state of the second switching mechanism while injecting air from the second air injection unit.

According to the present invention, the studs can be supplied at a correct posture to the welding electrode.

### BRIEF DESCRIPTION OF DRAWINGS

FIG. 1 is a diagram illustrating a projection welding system;

FIG. 2 is a diagram showing the external appearance of a stud;

FIG. 3 is a diagram showing the external appearance of a second electrode;

FIG. 4 is a diagram showing a cross section of a second retaining member;

FIG. 5 is a diagram showing a state in which cleaning air flows into the second retaining member;

FIG. 6 is a diagram showing the external appearance of a stud supplying device;

FIG. 7 is a diagram showing a side surface of the stud supplying device;

FIG. 8 is a diagram showing a cross section of a magazine;

FIG. 9 is a diagram showing the structure and a surrounding vicinity of a switching mechanism;

FIGS. 10A, 10B, 10C, 10D, and 10E are views showing a stud supplying procedure;

FIG. 11 is a diagram showing the external appearance of a stud filling device;

FIG. 12 is a diagram showing a side surface of the stud filling device;

FIG. 13A is a diagram showing a state in which the studs are accommodated in a tube;

FIG. 13B is a diagram showing a state in which the studs are supplied from the tube to the magazine;

FIG. 14A is a diagram showing a locked state of the switching mechanism;

FIG. 14B is a diagram showing an unlocked state of the switching mechanism;

FIG. 15 is a diagram showing a state in which the stud filling device is positioned underneath a stud delivery device;

FIG. 16 is a diagram showing a state in which the stud filling device is moved from underneath the stud delivery device;

FIG. 17 is a diagram showing a state in which the stud supplying device approaches the stud filling device;

FIG. 18 is a diagram showing a state in which the stud supplying device is positioned on the stud filling device; and

FIG. 19 is a diagram showing a state in which the studs are supplied from the stud filling device to the stud supplying device.

### DESCRIPTION OF THE INVENTION

Hereinafter, preferred embodiments concerning a stud supplying device and a stud supplying method according to the present invention will be presented and described in detail below with reference to the accompanying drawings.

### 1. Projection Welding System 10

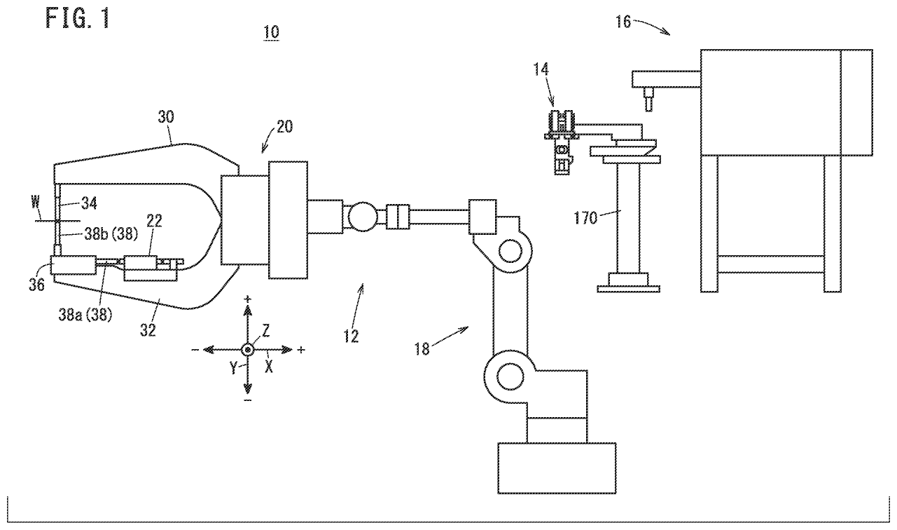

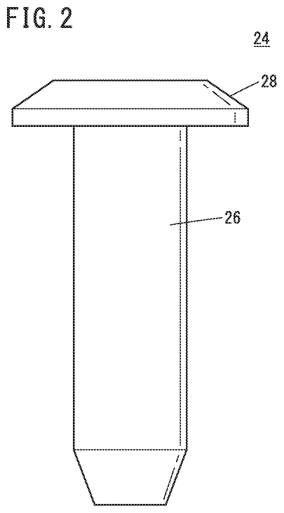

As shown in FIG. 1, a projection welding system 10 includes a projection welding device 12, a stud filling device 14, and a stud delivery device 16. The projection welding device 12 includes an articulated robot 18, a stud gun 20 operated by the robot 18, and a stud supplying device 22 that supplies studs 24 (see FIG. 2) to second electrodes 38 of the stud gun 20.

As shown in FIG. 2, the studs 24 that are used in the present embodiment are flanged studs each of which has a shaft portion 26, and a flange 28 formed at a proximal end of the shaft portion 26. The studs 24 are accommodated in the stud delivery device 16, are delivered from the stud delivery device 16 to the stud filling device 14, are delivered from the stud filling device 14 to the stud supplying device 22, are ejected from the stud supplying device 22, and are supplied to the second electrodes 38.

### 2. Stud Gun 20

An example of the stud gun 20 will briefly be described with reference to FIG. 1. In this instance, the respective directions are defined herein for the sake of convenience. According to the present embodiment, a longitudinal direction of the stud gun 20 is defined as an X direction (a left/right direction on the sheet of FIG. 1), a heightwise direction perpendicular to the X direction is defined as a Y direction (an up/down direction on the sheet of FIG. 1), and a widthwise direction perpendicular to the X direction and the Y direction is defined as a Z direction (a direction perpendicular to the sheet of FIG. 1). Further, the X direction is formed of a positive +X direction and a negative −X direction. The same features also apply to the Y direction and the Z direction.

The stud gun 20 includes a first arm 30 and a second arm 32 that can approach and separate away from each other. A first electrode 34, which serves as a welding electrode, is mounted on the distal end of the first arm 30 with the distal end thereof facing the second electrodes 38. An electrode switching device 36 is mounted on the distal end of the second arm 32. Further, the stud supplying device 22 is mounted on the second arm 32 on a proximal end side of the electrode switching device 36.

The electrode switching device 36 includes two second electrodes 38 that serve as welding electrodes. One of the second electrodes, which is a second electrode 38a, is disposed farther on the +Z direction side (the side toward the viewer on the sheet) than the other of the second electrodes, which is a second electrode 38b. The two second electrodes 38 are capable of swinging within an X-Y plane about an axis that extends in the Z direction, and are also capable of moving in the Z direction. The electrode switching device 36 is controlled by a non-illustrated control device.

In the case that the two second electrodes 38 are disposed on the +Z direction side (the side toward the viewer on the sheet), the distal end of the second electrode 38a is oriented toward the stud supplying device 22 on the +X direction side, and the distal end of the second electrode 38b is oriented toward the first electrode 34 on the +Y direction side. In this state, the first electrode 34 and the second electrode 38b carry out projection welding with the studs 24 and a workpiece W sandwiched therebetween, and the stud supplying device 22 supplies the studs 24 to the second electrode 38a.

In the case that the two second electrodes 38 are disposed on the −Z direction side (the side away from the viewer on the sheet), the distal end of the second electrode 38a is oriented toward the first electrode 34 on the +Y direction, and the distal end of the second electrode 38b is oriented toward the stud supplying device 22 on the +X direction side. In this state, the first electrode 34 and the second electrode 38a carry out projection welding with the studs 24 and the workpiece W sandwiched therebetween, and the stud supplying device 22 supplies the studs 24 to the second electrode 38b.

### 3. Second Electrodes 38

### [3.1. Configuration of Second Electrodes 38]

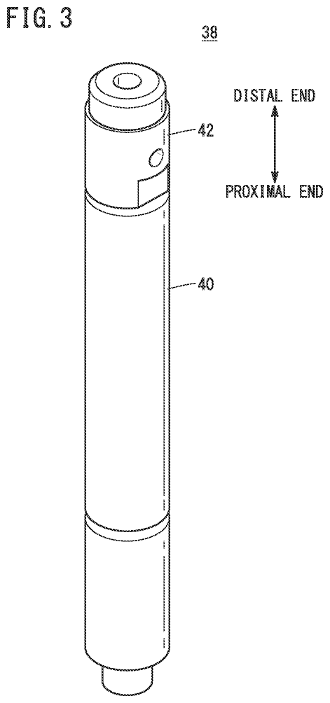

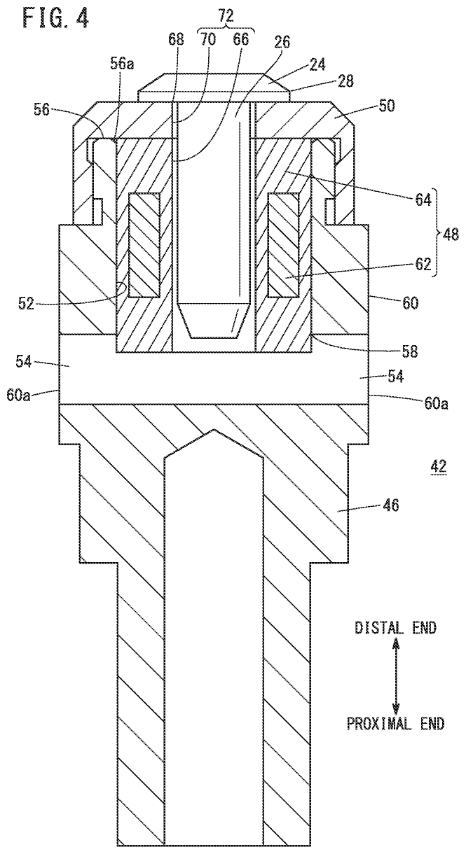

The configuration of the second electrodes 38 will be described with reference to FIGS. 3 and 4. In this instance, among the respective members constituting the second electrodes 38, an end portion on the distal end side of each of the second electrodes 38 is referred to as a distal end, and a portion positioned on the side of the distal end is referred to as a distal end portion. Further, among the respective members constituting the second electrodes 38, an end portion on the proximal end side of each of the second electrodes 38 is referred to as a proximal end, and a portion positioned on the side of the proximal end is referred to as a proximal end portion. Each of the second electrodes 38 includes a first retaining member 40 and a second retaining member 42.

The first retaining member 40 is a rod-shaped member positioned on the proximal end side of the second electrodes 38, and a conductive member (not shown) is inserted therein. The conductive member is connected to a circuit (not shown) that supplies a welding current. A proximal end portion of the first retaining member 40 is attached to a swing arm (not shown) of the electrode switching device 36. A distal end portion of the first retaining member 40 retains the second retaining member 42.

As shown in FIG. 4, the second retaining member 42 includes an electrode main body 46, a magnet member 48 that attracts the studs 24 by a magnetic force, and a cap 50 that functions as an electrode tip.

The electrode main body 46 is a conductive member such as metal, and includes a magnet accommodating hole 52 and one or more lateral holes 54 therein. The electrode main body 46 is mounted on the distal end portion of the first retaining member 40, and is connected to the conductive member of the first retaining member 40. The magnet accommodating hole 52 is formed along an axial line of the electrode main body 46, from a distal end opening 56a that is formed on a distal end surface 56 of the electrode main body 46 to a bottom portion 58 that is formed on a proximal end side of the distal end opening 56a. The lateral holes 54 are formed along a diameter of the electrode main body 46, from side wall openings 60a that are formed in a side wall 60 of the electrode main body 46 to the bottom portion 58.

The magnet member 48 includes a cylindrical magnet 62, and a non-magnetic body 64 that covers the entire surface of the magnet 62. The non-magnetic body 64 includes a first stud retaining hole 66 that penetrates through the center thereof. The magnet member 48 is fitted into the magnet accommodating hole 52 of the electrode main body 46, and is retained at a position where the lateral holes 54 are not blocked. Moreover, a flow path through which a coolant flows may be provided in the magnet member 48.

The cap 50 is a conductive member such as metal. The cap 50 includes a cap opening 68 formed at a distal end thereof, and a second stud retaining hole 70 connected to the cap opening 68 and penetrating through the center of the cap 50. The cap 50 is screwed into the side wall 60 at a distal end portion of the electrode main body 46, and comes into contact with the distal end of the electrode main body 46 and a distal end of the non-magnetic body 64 of the magnet member 48 that is fitted into the magnet accommodating hole 52.

The first stud retaining hole 66 and the second stud retaining hole 70 are aligned with the axial lines thereof coincident to each other to constitute a stud retaining hole 72. The stud retaining hole 72 is connected to the lateral holes 54 at the position of the bottom portion 58. Accordingly, the cap opening 68 (first opening) and the side wall openings 60a (second openings) communicate with each other through the stud retaining hole 72 and the lateral holes 54. The diameter of the stud retaining hole 72 is greater than the diameter of the shaft portion 26 of the stud 24. Further, the diameter of the cap opening 68 is less than the diameter of the flange 28 of the stud 24. The stud 24 is pulled inward by the magnetic force of the magnet 62, in a state in which the shaft portion 26 is inserted into the stud retaining hole 72 and the flange 28 is in contact with the distal end of the cap 50.

At a position facing the distal end of the second electrodes 38, an air injection unit is provided that injects air from the cap opening 68 (first opening) of the second electrodes 38 into the stud retaining hole 72. As noted previously, in accordance with the operation of the electrode switching device 36, the distal ends of the second electrodes 38 are oriented toward the stud supplying device 22. As will be described in item [4], the stud supplying device 22 is an air transport type stud supplying unit that inserts the studs 24 into the stud retaining hole 72 by using air pressure. According to the present embodiment, the stud supplying device 22 is used as the air injection unit.

### [3.2. Method for Cleaning the Second Electrodes 38]

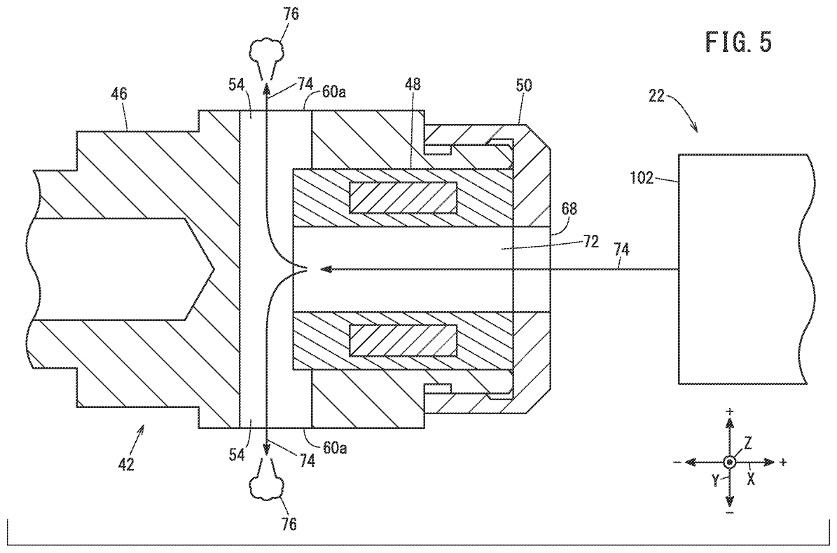

As shown in FIG. 5, when the second retaining member 42 for the second electrodes 38 is oriented toward the stud supplying device 22, the cap opening 68 and an ejection port 102 of a magazine 80 of the stud supplying device 22 face each other. In a state in which the stud 24 is not inserted into the stud retaining hole 72, the stud supplying device 22 injects cleaning air 74 from the ejection port 102 toward the cap opening 68. The cleaning air 74 flows into the stud retaining hole 72 from the cap opening 68, passes through the stud retaining hole 72 and the lateral holes 54, and flows out to the exterior from the side wall openings 60a. At this time, the cleaning air 74 blows dust or debris 76 that is accumulated in the stud retaining hole 72 and the lateral holes 54 to the exterior from the side wall openings 60a. As a result, the stud retaining hole 72 and the lateral holes 54 are cleaned by removal of the dust or debris 76.

### 4. Stud Supplying Device 22

### [4.1. Configuration of Stud Supplying Device 22]

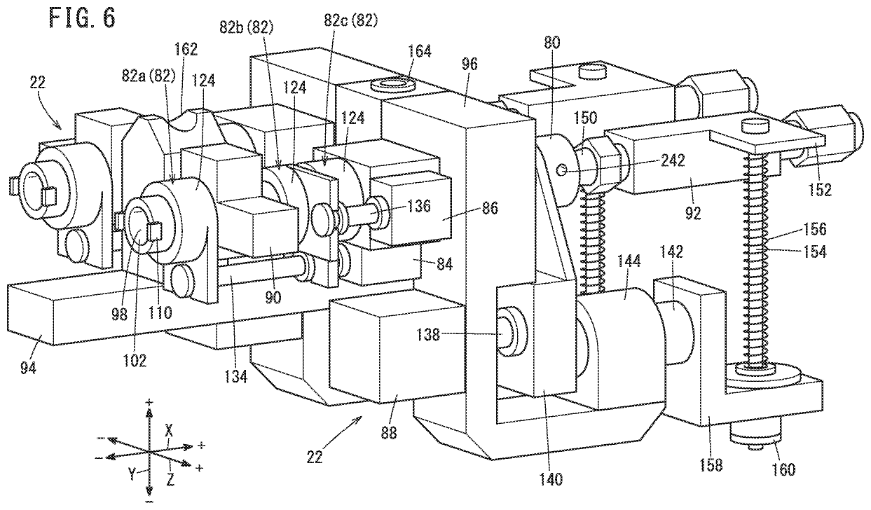

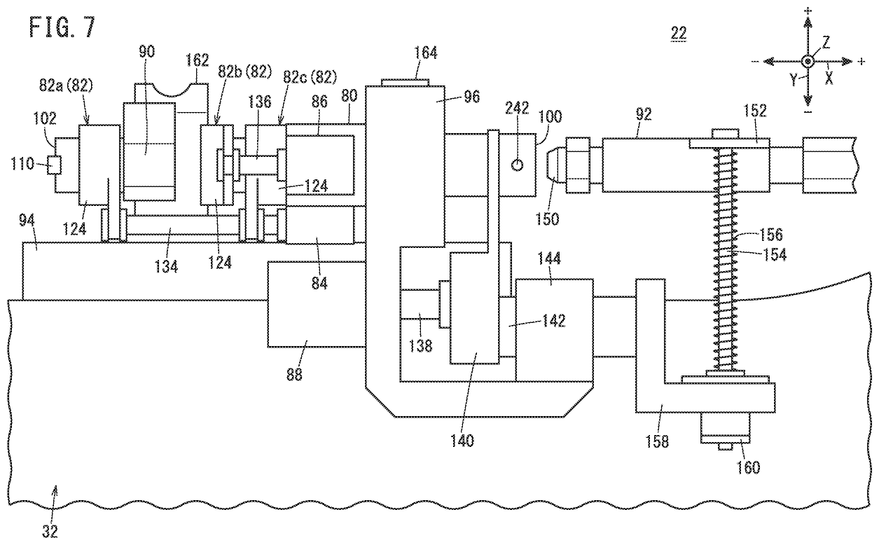

A description of the configuration of the stud supplying device 22 will be given with reference to FIGS. 6 to 9. In the present embodiment, the projection welding device 12 includes two stud supplying devices 22. One of the stud supplying devices 22 is arranged farther on the +Z direction side than the second arm 32 (see FIG. 7), and supplies the studs 24 to the second electrode 38a. The other of the stud supplying devices 22 is arranged farther on the −Z direction side than the second arm 32 (see FIG. 7), and supplies the studs 24 to the second electrode 38b.

Each of the stud supplying devices 22 includes the magazine 80, a plurality of switching mechanisms 82 (a first switching mechanism 82a to a third switching mechanism 82c), a first cylinder 84, a second cylinder 86, a third cylinder 88, a first air injection unit 90, and a second air injection unit 92. Further, a base 94 is fixed to an inner side surface (a surface on the first arm 30 side) of the second arm 32. A supporting member 96 is fixed to the base 94. The supporting member 96 spans across the second arm 32 and projects out toward the +Z direction side and the −Z direction side to support the two stud supplying devices 22.

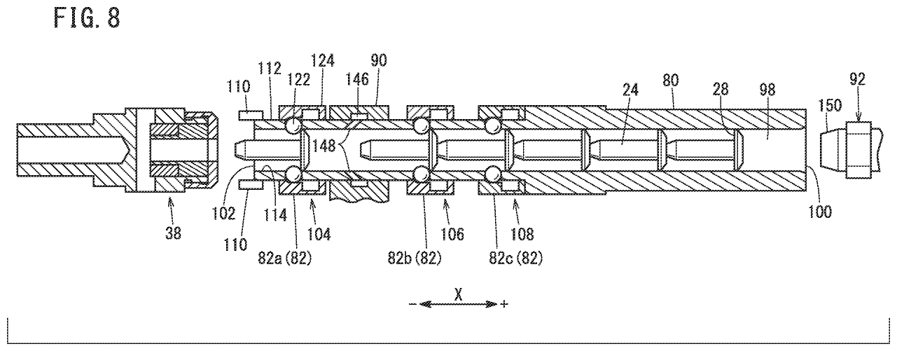

First, a description will be given concerning the magazine 80 that is supported by the supporting member 96. As shown in FIG. 8, the magazine 80 is a cylinder in which a predetermined number of the studs 24 are accommodated. The magazine 80 is arranged with the axial line thereof parallel to the X direction (the direction in which the studs 24 are supplied), and is supported by the supporting member 96 to be capable of moving in the +X direction and the −X direction. The magazine 80 includes a magazine hole 98 that penetrates from one end on the +X direction side to another end on the −X direction side, a guiding port 100 positioned at one end of the magazine hole 98, and the ejection port 102 positioned at another end of the magazine hole 98. A stopping member 104 that causes the stud 24 to stop immediately prior to being ejected is provided in a portion of the magazine hole 98 that is close to the ejection port 102.

Within the magazine hole 98, on the side closer to the guiding port 100 than the stopping member 104 (the +X direction side), a first standby section 106 and a second standby section 108 are provided, which cause the studs 24 to stop prior to being moved to the stopping member 104.

The diameter of the magazine hole 98 is greater than the diameter of the flange 28 of the stud 24 and less than a total length of the stud 24. Further, the length of the magazine hole 98 in the axial direction is longer than a total length of a predetermined number of the studs 24. Accordingly, the magazine 80 is capable of accommodating the predetermined number of the studs 24 aligned in series (in one row) from the stopping member 104 toward the +X direction side in the interior of the magazine hole 98. Further, the magazine 80 is capable of inserting the studs 24 from the guiding port 100 and ejecting the studs 24 from the ejection port 102. On a distal end of the magazine 80, a magazine sensor 110 is provided that detects a distal end of the stud 24 that is stopped at the stopping member 104. The magazine sensor 110, for example, is a photoelectric sensor.

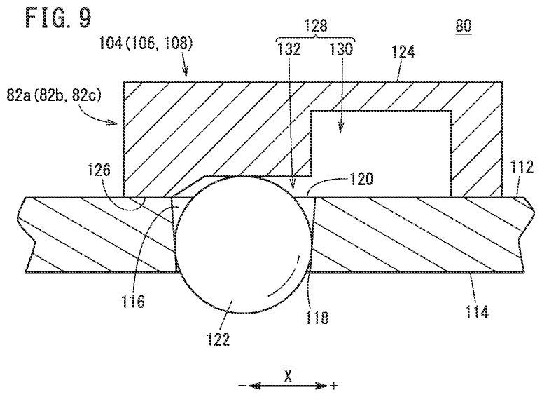

As shown in FIG. 9, the magazine 80 includes a plurality of magazine through holes 116 that penetrate from a magazine outer wall 112 to a magazine inner wall 114 at the position of the stopping member 104. The plurality of magazine through holes 116 are provided in the stopping member 104. The plurality of magazine through holes 116 are arranged in a circumferential direction of a cross section (a cross section perpendicular to the axial line of the magazine 80) of the stopping member 104. Further, the magazine 80 includes the magazine through holes 116 having the same shape as the stopping member 104 at the position of the first standby section 106 and the position of the second standby section 108. An interval between the first standby section 106 and the second standby section 108 is shorter than the length of the studs 24.

A first switching mechanism 82a is provided on the stopping member 104. The first switching mechanism 82a includes a plurality of balls 122 (FIGS. 8 and 9) and a reciprocating member 124 (FIGS. 6 to 9). The first switching mechanism 82a switches between a state in which the studs 24 are stopped at the stopping member 104, and a state in which the studs 24 are allowed to pass through the stopping member 104.

Each of the balls 122 is accommodated in the interior of each of the magazine through holes 116, and is capable of moving between an inner side and an outer side in a radial direction of the magazine 80 inside the magazine through hole 116. The ball 122 is smaller than an outer wall opening 120 and larger than an inner wall opening 118 of the magazine through hole 116. When an outer end portion of the ball 122 is positioned in the vicinity of the outer wall opening 120, a portion of the ball 122 protrudes from the inner wall opening 118 into the interior of the magazine hole 98.

The reciprocating member 124 is a cylindrical member. The reciprocating member 124 is disposed around the circumference of the magazine outer wall 112, and is capable of sliding in the +X direction and the −X direction along the magazine outer wall 112. The reciprocating member 124 includes an encircling recessed portion 128 on an inner circumferential surface 126 thereof facing the magazine outer wall 112. The recessed portion 128 includes a large diameter portion 130 having a large diameter on the +X direction side, and includes a small diameter portion 132 having a small diameter on the −X direction side.

A second switching mechanism 82b switches between a state in which the studs 24 are stopped at the first standby section 106, and a state in which the studs 24 are allowed to pass through the first standby section 106. A third switching mechanism 82c switches between a state in which the studs 24 are stopped at the second standby section 108, and a state in which the studs 24 are allowed to pass through the second standby section 108. The structure and operations of the second switching mechanism 82b and the third switching mechanism 82c are the same as the structure and operations of the first switching mechanism 82a.

The switching mechanisms 82 operate in the following manner. In the case that the reciprocating member 124 is moved in the −X direction, and the large diameter portion 130 of the reciprocating member 124 faces directly in front of the outer wall opening 120 of the magazine through hole 116, the ball 122 becomes capable of moving between the large diameter portion 130 and the magazine through hole 116. At this time, the plurality of balls 122 become capable of making the size of the magazine hole 98 (see FIG. 8) greater than the diameter of the flanges 28 of the studs 24. Upon doing so, because the studs 24 push the plurality of balls 122 to the outer side and widen the diameter of the stopping member 104, the studs 24 become capable of passing through the stopping member 104.

In the case that the reciprocating member 124 is moved in the +X direction, and the small diameter portion 132 of the reciprocating member 124 faces directly in front of the outer wall opening 120 of the magazine through hole 116, the ball 122 comes into contact with a circumferential surface of the small diameter portion 132. As a result, movement of the ball 122 is restricted by the reciprocating member 124, in a state where a portion of the ball 122 protrudes from the inner wall opening 118 of the magazine through hole 116 into the interior of the magazine hole 98. Upon doing so, since the studs 24 cannot push the plurality of balls 122 toward the outer side, the studs 24 become incapable of passing through the stopping member 104.

Returning to FIGS. 6 and 7, the description of the configuration of the stud supplying device 22 will be continued. The first cylinder 84 is a fluid pressure cylinder that causes a first rod 134 to operate in the +X direction and the −X direction. The first cylinder 84 is arranged farther on the +X direction side than the first switching mechanism 82a to the third switching mechanism 82c, and is connected to the magazine 80. The first rod 134 extends from the first cylinder 84 in the −X direction, and is connected to the reciprocating member 124 of the first switching mechanism 82a and the reciprocating member 124 of the third switching mechanism 82c. The first cylinder 84 operates the first switching mechanism 82a and the third switching mechanism 82c simultaneously.

The second cylinder 86 is a fluid pressure cylinder that causes a second rod 136 to operate in the +X direction and the −X direction. The second cylinder 86 is arranged farther on the +X direction side than the first switching mechanism 82a to the third switching mechanism 82c, and is fixed to the magazine 80. The second rod 136 extends from the second cylinder 86 in the −X direction, and is connected to the reciprocating member 124 of the second switching mechanism 82b. The second cylinder 86 operates the second switching mechanism 82b separately from the first switching mechanism 82a and the third switching mechanism 82c.

The third cylinder 88 is a fluid pressure cylinder that causes a third rod 138 to operate in the +X direction and the −X direction. The third cylinder 88 is fixed to a surface of the supporting member 96 on the −X direction side. The third rod 138 penetrates through the supporting member 96 and extends in the +X direction, and is connected to a surface of a connecting plate 140 that is fixed to a proximal end portion of the magazine 80, the surface being on the −X direction side. On the other hand, a first guide shaft 142 is connected to a surface of the connecting plate 140 on the +X direction side.

The first guide shaft 142 extends in the +X direction from the connecting plate 140, and is connected to a pedestal 158 of the second air injection unit 92, which will be described later. The first guide shaft 142 is movably supported in the +X direction and the −X direction by a guide member 144 that is fixed to an end portion of the supporting member 96 on the +X direction side. The third cylinder 88 operates, in the +X direction and the −X direction with reference to the supporting member 96, the members connected to the connecting plate 140, more specifically, the magazine 80 and the components (the switching mechanisms 82, the first cylinder 84, the second cylinder 86, the first air injection unit 90, and the like) connected thereto, and the components (the second air injection unit 92 and the like) connected to the pedestal 158.

As shown in FIG. 8, the first air injection unit 90 is disposed between the stopping member 104 and the first standby section 106 of the magazine 80. The first air injection unit 90 includes an air supplying pathway 146 that encircles the magazine outer wall 112. The first air injection unit 90 is connected to an air supplying circuit (not shown) including an air pump. On the other hand, an air supplying hole 148 is formed in the magazine 80 from the magazine outer wall 112 to the magazine inner wall 114. The air supplying hole 148 is provided in plurality. The air supplying holes 148 communicate with the air supplying pathway 146. The air supplying holes 148 have a structure in which flow paths thereof on a downstream side are positioned farther on the −X direction side than flow paths thereof on an upstream side. Therefore, the first air injection unit 90 injects air, which flows into the air supplying holes 148 from the air supplying pathway 146, toward the −X direction inside the magazine hole 98.

The second air injection unit 92 is provided farther on the +X direction side than the proximal end of the magazine 80. The second air injection unit 92 is connected to an air supplying circuit (not shown) including an air pump. The second air injection unit 92 brings a nozzle 150 closer to the guiding port 100 of the magazine 80. Therefore, the second air injection unit 92 injects air from the nozzle 150 toward the interior of the magazine hole 98. The second air injection unit 92 includes an injection unit bracket 152 that extends in the +Z direction.

A second guide shaft 154 is parallel to the Y direction, and is inserted into a coil spring 156 and a hole formed in the pedestal 158. An end of the second guide shaft 154 on the +Y direction side is fixed to the injection unit bracket 152, and an end of the second guide shaft 154 on the −Y direction side is fixed to a stopping member 160 at a location farther on the −Y direction side than the pedestal 158. Since the stopping member 160 is larger than the hole of the pedestal 158 into which the second guide shaft 154 is inserted, the second guide shaft 154 does not come out from the hole. The coil spring 156 abuts against an end surface of the injection unit bracket 152 on the −Y direction side and an end surface of the pedestal 158 on the +Y direction side.

Due to such a configuration, the second air injection unit 92 stops the nozzle 150 in a state of being in close proximity to the proximal end of the magazine 80, and supplies air to the magazine hole 98 of the magazine 80. Further, by being pushed in the −Y direction, the second air injection unit 92 is capable of compressing the coil spring 156 and moving toward the −Y direction side. In this state, since the guiding port 100 of the magazine 80 is not blocked by the second air injection unit 92, it becomes possible to perform an operation of filling the studs 24 into the magazine hole 98 of the magazine 80.

The operation of filling the studs 24 into the magazine hole 98 is carried out by the stud filling device 14 (refer to FIG. 1, etc.). In order to prevent misalignment between the stud supplying device 22 and the stud filling device 14, the stud supplying device 22 is provided with a first male portion 162 and a first female portion 164. The first male portion 162 is fixed to the base 94 and projects out in the +Y direction from a location between the magazine 80 of one of the stud supplying devices 22 and the magazine 80 of another one of the stud supplying devices 22. The first female portion 164 is fixed to a surface of the supporting member 96 on the +Y direction side. The operation of filling the studs 24 will be described in item [5.2].

### [4.2. Stud Supplying Procedure]

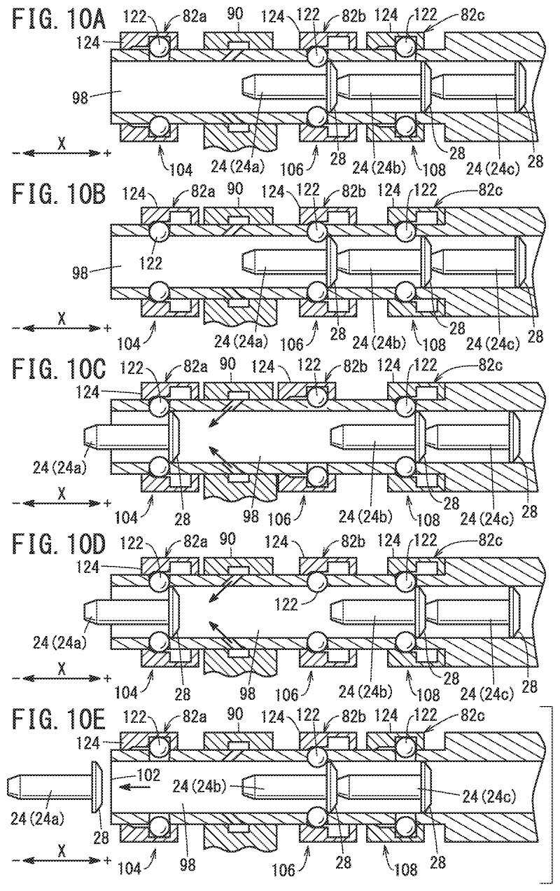

A procedure for supplying the studs 24 from the stud supplying device 22 to the second electrodes 38, and a procedure for delivering the studs 24 to the distal end side in the interior of the magazine hole 98 will be described with reference to FIGS. 10A to 10E. In the following description, each of the switching mechanisms 82 (82a to 82c) operates the reciprocating member 124 to switch between a state in which movement of the balls 122 is restricted and a state in which the restriction on movement of the balls 122 is released. Hereinafter, the state in which the switching mechanism 82 restricts movement of the balls 122 is referred to as a locked state, and the state in which the switching mechanism 82 releases the restriction on movement of the balls 122 is referred to as an unlocked state. Moreover, in this instance, a description will be given of a state in which three of the studs 24 are accommodated in the magazine hole 98. The three studs 24 may also be referred to as a first stud 24a, a second stud 24b, and a third stud 24c, in order from a leading one of them.

FIG. 10A shows a first step in which the studs 24 are filled into the magazine hole 98. The second cylinder 86 (see FIG. 6, etc.) causes the reciprocating member 124 of the second switching mechanism 82b to be arranged on the +X direction side, and thereby places the second switching mechanism 82b in a locked state. The first cylinder 84 causes the reciprocating member 124 of the third switching mechanism 82c to be arranged on the −X direction side, and thereby places the third switching mechanism 82c in an unlocked state. In this state, when a predetermined number (a plurality) of the studs 24 are filled from the proximal end of the magazine hole 98, the balls 122 of the third switching mechanism 82c are pushed by the first stud 24a and moved to the outer side. As a result, the first stud 24a passes through the second standby section 108. Further, the balls 122 of the second switching mechanism 82b come into contact with the flange 28 of the first stud 24a. Therefore, the first stud 24a is stopped at the first standby section 106. At this time, the second stud 24b abuts against the first stud 24a, and comes to a stop farther on the +X direction side than the second standby section 108. As a result, the state shown in FIG. 10A is brought about.

FIG. 10B shows a second step which is performed following the first step. The first cylinder 84 (see FIG. 6, etc.) causes the reciprocating members 124 of the first switching mechanism 82a and the third switching mechanism 82c to be arranged on the +X direction side, and thereby places the first switching mechanism 82a and the third switching mechanism 82c in a locked state. As a result, the state shown in FIG. 10B is brought about. At this time, the stopped position of each of the studs 24 does not change. In this state, air is injected into the interior of the magazine hole 98 from the second air injection unit 92 (refer to FIG. 6, etc.). The posture of each of the studs 24 is corrected by the air, and the distal ends thereof are oriented in the direction in which the air flows, namely, in the −X direction.

FIG. 10C shows a third step which is performed following the second step. The second cylinder 86 causes the reciprocating member 124 of the second switching mechanism 82b to be arranged on the −X direction side, and thereby places the second switching mechanism 82b in an unlocked state. The balls 122 of the second switching mechanism 82b are pushed by the first stud 24a to which a propulsive force has been applied by the air, and thus the balls 122 are moved to the outer side. As a result, the first stud 24a passes through the first standby section 106 and advances to the stopping member 104. The balls 122 of the first switching mechanism 82a come into contact with the flange 28 of the first stud 24a. Therefore, the first stud 24a is stopped at the stopping member 104. Furthermore, the second stud 24b to which the propulsive force has been applied by the air advances to the second standby section 108. The balls 122 of the third switching mechanism 82c come into contact with the flange 28 of the second stud 24b. Therefore, the second stud 24b is stopped at the second standby section 108. In this state, air is injected into the interior of the magazine hole 98 from the first air injection unit 90. The posture of the first stud 24a is corrected by the air, and the distal end thereof is oriented in the direction in which the air flows, namely, in the −X direction. As a result, the state shown in FIG. 10C is brought about.

FIG. 10D shows a fourth step which is performed following the third step. The second cylinder 86 causes the reciprocating member 124 of the second switching mechanism 82b to be arranged on the +X direction side, and thereby places the second switching mechanism 82b in a locked state. As a result, the state shown in FIG. 10D is brought about. At this time, the stopped position of each of the studs 24 does not change.

FIG. 10E shows a fifth step which is performed following the fourth step. The first cylinder 84 causes the reciprocating members 124 of the first switching mechanism 82a and the third switching mechanism 82c to be arranged on the −X direction side, and thereby places the first switching mechanism 82a and the third switching mechanism 82c in an unlocked state. The balls 122 of the first switching mechanism 82a are pushed by the first stud 24a to which a propulsive force has been applied by the air, and thus the balls 122 are moved to the outer side. As a result, the first stud 24a passes through the stopping member 104, and is ejected from the ejection port 102. Further, the balls 122 of the second switching mechanism 82b come into contact with the flange 28 of the second stud 24b. Therefore, the second stud 24b is stopped at the first standby section 106. At this time, the third stud 24c abuts against the second stud 24b, and comes to a stop farther on the +X direction side than the second standby section 108. As a result, the state shown in FIG. 10E is brought about. This state is the same as the state of the first step shown in FIG. 10A. Accordingly, thereafter, the processes of the second step to the fifth step are repeated.

### 5. Stud Filling Device 14

### [5.1. Configuration of the Stud Filling Device 14]

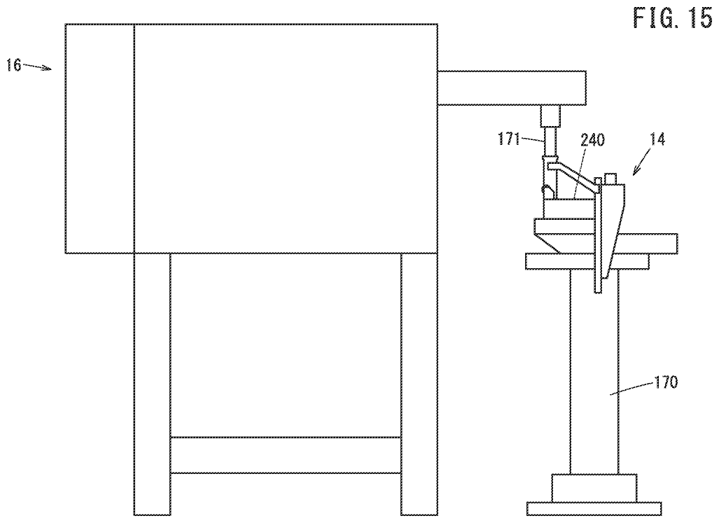

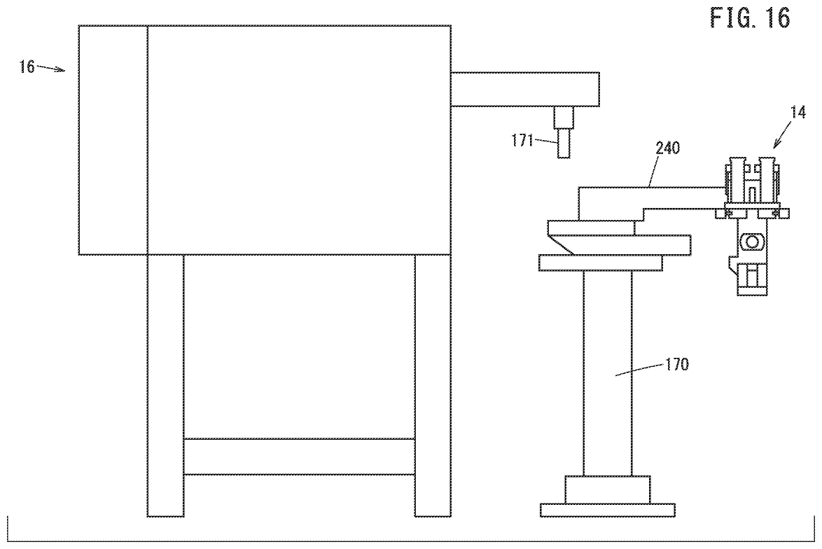

A description of the configuration of the stud filling device 14 will be given with reference to FIGS. 1 and 11 to 16. As shown in FIG. 1, the stud filling device 14 is supported by a supporting base 170, rotates about an axis that extends in the vertical direction, and is capable of moving between a position where the studs 24 are received from the stud delivery device 16 (see FIG. 15), and a position where the studs 24 are filled in the stud supplying device 22 (see FIG. 16).

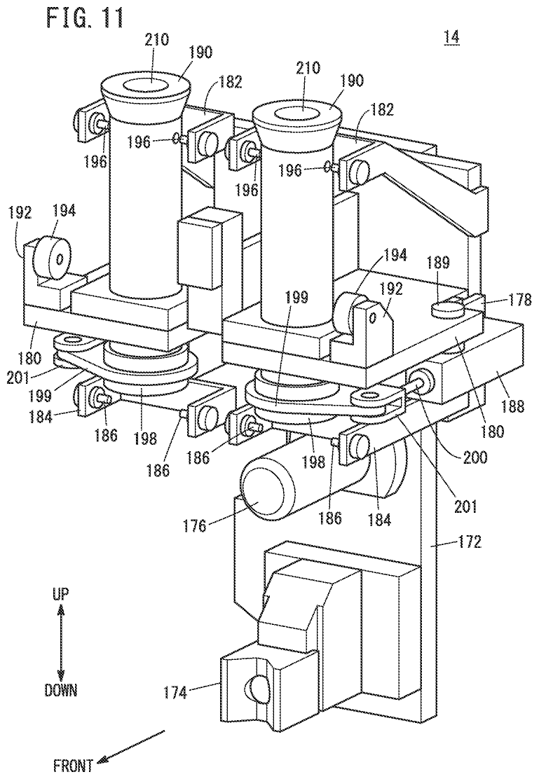

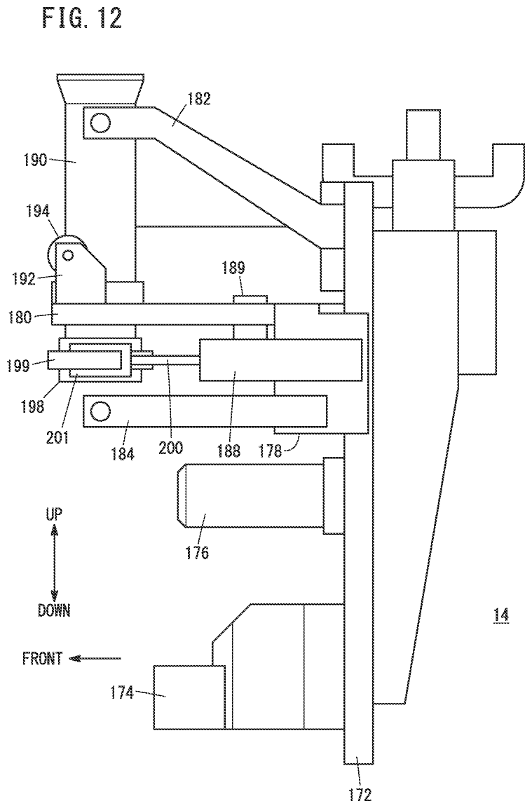

As shown in FIGS. 11 and 12, the stud filling device 14 is constituted by a plurality of components that are mounted on a vertical plate 172 supported by the supporting base 170, and a plurality of components that are mounted on those components. A second female portion 174, a second male portion 176, two first brackets 178, two horizontal plates 180, and two second brackets 182 are mounted on the vertical plate 172 in this order from below.

The second female portion 174 and the second male portion 176 project out in a frontward direction from the vertical plate 172. The two first brackets 178 extend in the frontward direction from the vertical plate 172, and individually support sensor supporting members 184. The sensor supporting members 184 support lower side tube sensors 186. The lower side tube sensors 186 are arranged more downward than lower ends of tubes 190. The two horizontal plates 180 extend in the frontward direction from the vertical plate 172, and individually support the tubes 190 and roller supporting members 192. Pins 189 that extend downward are mounted on the horizontal plates 180 so as to be rotatable about axial lines thereof. A fourth cylinder 188 is fixed to lower ends of the pins 189. The pins 189 rotatably support the fourth cylinder 188. The roller supporting members 192 rotatably support rollers 194, respectively. The rollers 194 project out more frontward than the tubes 190. The two second brackets 182 extend in the frontward direction from the vertical plate 172, and individually support upper side tube sensors 196.

The tubes 190 extend in the vertical direction and are supported by the horizontal plates 180. Upper ends of the tubes 190 are disposed above the horizontal plates 180, and lower ends of the tubes 190 are disposed below the horizontal plates 180. Switching mechanisms 198 are provided at the lower ends of the tubes 190 that are disposed below the horizontal plates 180. One of the tubes 190 fills the studs 24 into one of the two stud supplying devices 22, and the other of the tubes 190 fills the studs 24 into the other of the two stud supplying devices 22.

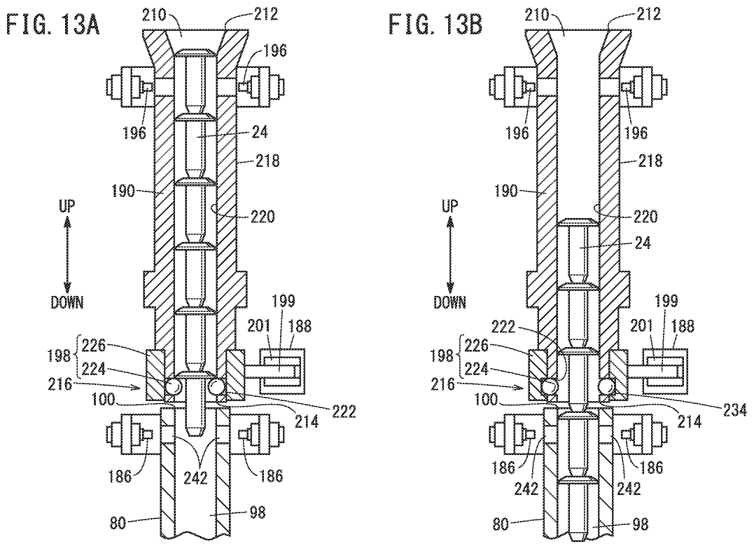

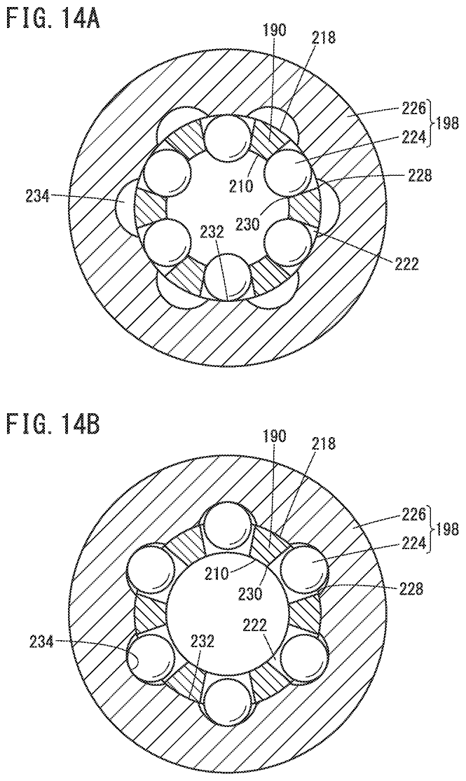

A flange 199 that extends in a horizontal direction is formed on the outer circumferential surface of each of the switching mechanisms 198. A shaft member of a joint 201 is inserted through a portion of the flange 199. The shaft member of the joint 201 extends in the vertical direction. A rear end of the joint 201 is connected to a distal end of a fourth rod 200 that extends in the frontward direction from the fourth cylinder 188. Due to this structure, when the fourth cylinder 188 causes the fourth rod 200 to move in the frontward direction or a rearward direction, a rotating member 226 (see FIGS. 14A and 14B) of the switching mechanism 198 rotates in one direction or an opposite direction about an axial center of a stopping member 216 (see FIGS. 13A and 13B). At this time, the fourth cylinder 188 rotates about the pin 189.

As shown in FIGS. 13A and 13B, each of the tubes 190 is a cylinder in which a predetermined number of the studs 24 are accommodated. Each of the tubes 190 includes a tube hole 210 that penetrates from one end on an upper side to another end on a lower side, a guiding port 212 positioned at one end of the tube hole 210, and a discharge port 214 located at another end of the tube hole 210. The stopping member 216 which causes a leading one of the studs 24 to be stopped is provided in a portion of the tube hole 210 that is close to the discharge port 214.

The diameter of the tube hole 210 is greater than the diameter of the flange 28 of the stud 24 and less than a total length of the stud 24. Further, the length of the tube hole 210 in the axial direction is longer than a total length of a predetermined number of the studs 24. Accordingly, each of the tubes 190 is capable of accommodating the predetermined number of the studs 24 aligned in series (in one row) downwardly from the stopping member 216 in the interior of the tube hole 210. Further, each of the tubes 190 is capable of inserting the studs 24 from the guiding port 212 and ejecting the studs 24 from the discharge port 214.

Lower side tube sensors 186, which detect the distal end of the stud 24 that is stopped at the stopping member 216, are provided below the lower end of each of the tubes 190. Further, the upper side tube sensors 196, which detect the stud 24 positioned at the tail end among the predetermined number of studs 24 that are accommodated in the tube hole 210, are provided at the upper end portion of each of the tubes 190. The lower side tube sensors 186 and the upper side tube sensors 196, for example, are photoelectric sensors.

Each of the tubes 190 includes a plurality of tube through holes 222 that penetrate from a tube outer wall 218 to a tube inner wall 220, at the position of the stopping member 216. The plurality of tube through holes 222 are arranged in a circumferential direction of a cross section (a cross section perpendicular to the axial line of the tubes 190) of the stopping member 216.

As shown in FIGS. 14A and 14B, each of the switching mechanisms 198 includes a plurality of balls 224 and the rotating member 226. The switching mechanism 198 switches between a state in which the studs 24 are stopped at the stopping member 216, and a state in which the studs 24 are allowed to pass through the stopping member 216.

Each of the balls 224 is accommodated in the interior of each of the tube through holes 222, and is capable of moving between an inner side and an outer side in a radial direction of the tube 190 inside the tube through hole 222. The ball 224 is smaller than an outer wall opening 228 and larger than an inner wall opening 230 of the tube through hole 222. When an outer end portion of the ball 224 is positioned in the vicinity of the outer wall opening 228, a portion of the ball 224 protrudes from the inner wall opening 230 into the interior of the tube hole 210.

The rotating member 226 is a cylindrical member. The rotating member 226 is provided around the circumference of the tube outer wall 218, and is capable of sliding along the tube outer wall 218 in a circumferential direction of the tube 190. The rotating member 226 includes recessed portions 234 on an inner circumferential surface 232 thereof facing the tube outer wall 218. The recessed portions 234 are arranged in a circumferential direction of a cross section (a cross section perpendicular to the axial line of the tubes 190) of the stopping member 216.

The switching mechanisms 198 operate in the following manner. In the case that the rotating member 226 is rotated, and the recessed portion 234 of the rotating member 226 faces directly in front of the outer wall opening 228 of the tube through hole 222, the ball 224 becomes capable of moving between the recessed portion 234 and the tube through hole 222. At this time, the plurality of balls 224 become capable of making the size of the stopping member 216 greater than the diameter of the flanges 28 of the studs 24. Upon doing so, because the studs 24 push the plurality of balls 224 to the outer side by their own weights and widen the diameter of the stopping member 216, the studs 24 become capable of passing through the stopping member 216.

In the case that the rotating member 226 is rotated, and the recessed portion 234 of the rotating member 226 does not face directly in front of the outer wall opening 228 of the tube through hole 222, the ball 224 comes into contact with the inner circumferential surface 232. As a result, movement of the ball 224 is restricted by the rotating member 226, in a state where a portion of the ball 224 protrudes from the inner wall opening 230 of the tube through hole 222 into the interior of the tube hole 210. Upon doing so, since the studs 24 cannot push the plurality of balls 224 toward the outer side, the studs 24 become incapable of passing through the stopping member 216.

### [5.2. Stud Filling Procedure]

A description of a procedure of delivering the studs 24 from the stud delivery device 16 to the stud filling device 14, and then supplying the studs 24 from the stud filling device 14 to the stud supplying device 22 will be given with reference to FIGS. 15 to 19. In the following description, the switching mechanism 198 operates the rotating member 226 to switch between a state in which movement of the balls 224 is restricted and a state in which the restriction on movement of the balls 224 is released. Hereinafter, the state in which the switching mechanism 198 restricts movement of the balls 224 is referred to as a locked state, and the state in which the switching mechanism 198 releases the restriction on movement of the balls 122 is referred to as an unlocked state. Moreover, in the following description, a control device (not shown) controls operations of each of the devices in an integrated manner.

Initially, a first positioning step is carried out. As shown in FIG. 15, the supporting base 170 causes the stud filling device 14 to be arranged underneath a stud delivering portion 171 of the stud delivery device 16. An arm 240 provided on the supporting base 170 is capable of being rotated between two positions. When the arm 240 is rotated in one direction, the stud filling device 14 is arranged underneath the stud delivering portion 171 of the stud delivery device 16, and can receive the studs 24 from the stud delivery device 16.

Next, a component accommodating step is performed. As shown in FIG. 14A, the fourth cylinder 188 causes the rotating member 226 of the switching mechanism 198 to rotate, and thereby places the switching mechanism 198 in a locked state. Upon doing so, the balls 224 are moved to the interior of the stopping member 216, and thereby make the size of the stopping member 216 smaller than the flanges 28 of the studs 24. In this state, the stud delivery device 16 allows a predetermined number of the studs 24 to fall downward into the tube hole 210. The studs 24 are inserted into the tube hole 210 with the distal ends thereof oriented downward. As shown in FIG. 13A, when a predetermined number of the studs 24 are accommodated in the tube hole 210, the upper side tube sensors 196 detect a state in which filling is completed. Upon doing so, the stud delivery device 16 stops supplying the studs 24.

Next, a second positioning step is carried out. As shown in FIG. 16, the supporting base 170 causes the stud filling device 14 to move from underneath the stud delivery device 16. When the arm 240 is rotated in the other direction, the stud filling device 14 moves from underneath the stud delivery device 16.

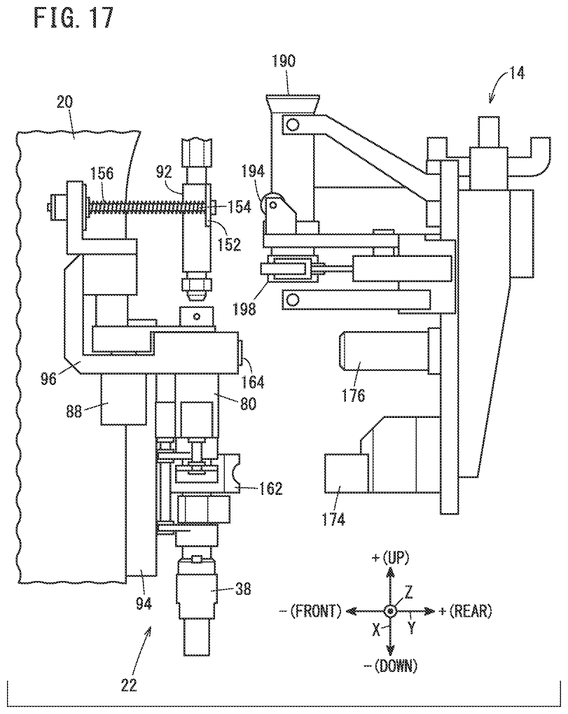

As shown in FIG. 17, the robot 18 places the stud supplying device 22 in closer proximity to the stud filling device 14 with the distal end side (the −X direction side) of the stud gun 20 oriented downward. At this time, the robot 18 adjusts the position of the stud supplying device 22 in the X direction and the Z direction, and causes the stud supplying device 22 to be moved in front of the stud filling device 14. Upon doing so, the robot 18 arranges the injection unit bracket 152 in front of the roller 194, arranges the first female portion 164 in front of the second male portion 176, and arranges the first male portion 162 in front of the second female portion 174.

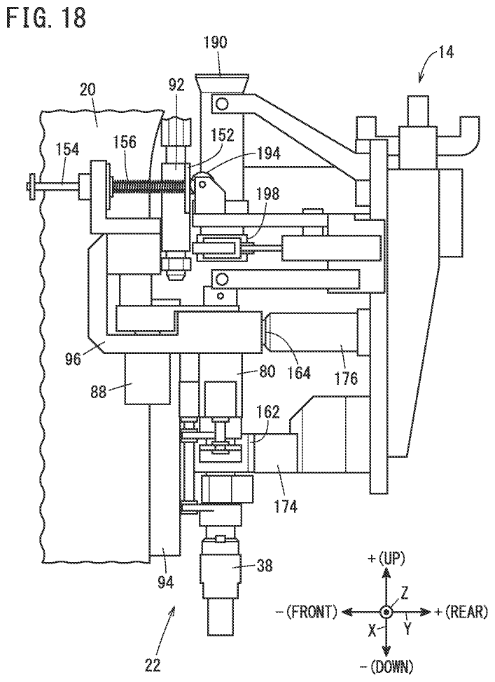

In this state, the robot 18 gradually moves the stud gun 20 in a rearward direction (the +Y direction), and places the stud supplying device 22 in closer proximity to the stud filling device 14. Upon doing so, the injection unit bracket 152 and the roller 194 come into contact with each other. Further, the robot 18 moves the stud gun 20 in the rearward direction (the +Y direction). Upon doing so, as shown in FIG. 18, the second air injection unit 92 moves in a frontward direction (the −Y direction) together with the injection unit bracket 152 and the second guide shaft 154. At this time, the coil spring 156 is compressed. When the first female portion 164 and the second male portion 176 come into contact with each other, and the first male portion 162 and the second female portion 174 come into contact with each other, the robot 18 causes the movement of the stud gun 20 to stop. At this time, the axial line of the tube 190 and the axial line of the magazine 80 coincide with each other.

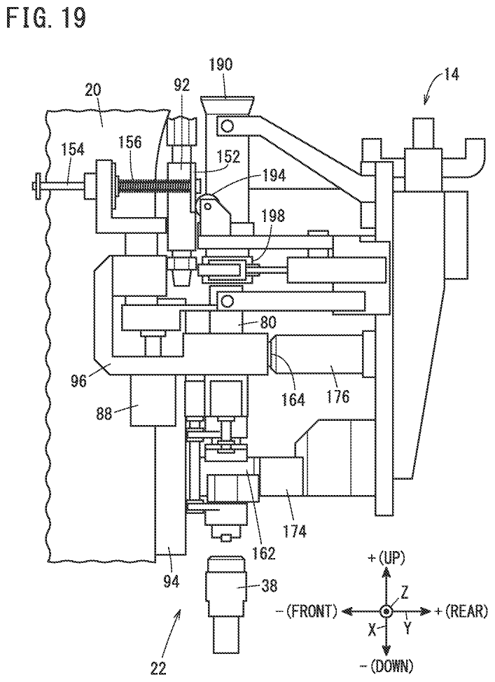

In this state, as shown in FIG. 19, the third cylinder 88 moves the magazine 80 in an upward direction (the +X direction). The injection unit bracket 152 is smoothly moved in the upward direction (the +X direction) due to rotation of the roller 194. On the other hand, the first male portion 162 that is fixed to the base 94, and the first female portion 164 that is fixed to the supporting member 96 do not move.

When the magazine 80 is moved in the upward direction (the +X direction), as shown in FIG. 13A, the guiding port 100 of the magazine 80 is brought in close proximity to the discharge port 214 of the tube 190. At this time, the positions of light passage holes 242, which are formed around the guiding port 100 of the magazine 80, and the positions of the lower side tube sensors 186 are aligned, and the lower side tube sensors 186 become capable of detecting that the predetermined number of studs 24 are accommodated in the magazine 80.

Next, a component filling step is performed. As shown in FIGS. 13B and 14B, the fourth cylinder 188 causes the rotating member 226 of the switching mechanism 198 to rotate, and thereby places the switching mechanism 198 in a locked state. The balls 224 are pushed by the weight of the studs 24 toward the outer side of the stopping member 216. Therefore, the balls 224 are moved toward the outer side of the stopping member 216, and thereby make the size of the stopping member 216 greater than the flanges 28 of the studs 24. Upon doing so, the studs 24 fall downward and are inserted into the magazine hole 98 with the distal ends thereof oriented downward. When a predetermined number of the studs 24 accommodated in the tube hole 210 are supplied to the magazine hole 98, filling of the magazine 80 is brought to an end.

### 6. Modifications

The configuration of the stud supplying device 22 and the stud filling device 14 as described above can be used for other types of component supplying devices and component filling devices. For example, the configuration of the stud supplying device 22 can be used for a bolt supplying device that supplies bolts to an arm tip of the robot 18. Further, the configuration of the stud filling device 14 can be used for a bolt filling device or the like for filling bolts into the bolt supplying device.

### 7. Technical Concepts that can be Obtained from the Embodiments

Descriptions are given below concerning the technical concepts that can be grasped from the above-described embodiments.

The first aspect of the present invention is characterized by the stud supplying device 22 that supplies the studs 24 to be welded onto the workpiece W to the welding electrode (the second electrodes 38) of the projection welding device 12, the stud supplying device 22 comprising:

the magazine 80 including the magazine hole 98 that penetrates therethrough in the direction (the X direction) in which the studs 24 are supplied to the welding electrode (the second electrodes 38), wherein the studs 24 are capable of being inserted from one end (the guiding port 100) and ejected from another end (the ejection port 102) of the magazine hole 98, the studs 24 are capable of being stopped at the stopping member 104 positioned on the other end side of the magazine hole 98, and the predetermined number of the studs 24 are capable of being accommodated inside the magazine hole 98 in series and in alignment from the stopping member 104 toward the one end side;

the switching mechanism 82 including the plurality of movable bodies (the balls 122) that are capable of moving between the position in which the movable bodies come into contact with the studs 24 and the position in which the movable bodies do not come into contact with the studs 24, and the locking member (the reciprocating member 124) that restricts movement of the plurality of movable bodies (the balls 122), the switching mechanism 82 switching between the state in which the studs 24 are stopped at the stopping member 104 and the state in which the studs 24 are allowed to pass; and

the air injection unit (the first air injection unit 90) that is disposed farther on the one end side than the stopping member 104, and that injects the air from the one end side to the studs 24 that are stopped at the stopping member 104.

According to the above-described configuration, when the locking member (the reciprocating member 124) restricts movement of, and more specifically locks, the movable bodies (the balls 122), the studs 24 can be stopped at the stopping member 104. When the studs 24 are stopped at the stopping member 104, the air injection unit (the first air injection unit 90) injects the air toward the studs 24 from the one end side, whereby the posture of the studs 24 can be corrected. At this time, the studs 24 are stopped in a posture in which the distal ends thereof are oriented in the direction in which the air flows. In this state, when the locking member (the reciprocating member 124) places the movable bodies (the balls 122) in the locked state, the studs 24 are ejected out from the ejection port 102 of the magazine hole 98 while the posture with the distal ends thereof oriented in the direction in which the air flows is maintained, and the studs arrive at the welding electrode (the second electrodes 38). In this manner, according to the above-described configuration, the studs 24 can be supplied at a correct posture to the welding electrode (the second electrodes 38).

In the first aspect of the present invention:

the plurality of movable bodies (the balls 122) may be arranged alongside one another in a circumferential direction of a cross section of the stopping member 104, and may be capable of moving toward an interior of the stopping member 104 and making a size of the stopping member 104 smaller than a size of the studs 24 to cause the studs 24 to stop, and may be capable of moving toward an outer side of the stopping member 104 and making the size of the stopping member 104 greater than the size of the studs 24 to allow the studs 24 to pass; and

the locking member (the reciprocating member 124) may restrict movement of the plurality of movable bodies (the balls 122) in the state in which the movable bodies (the balls 122) have made the size of the stopping member 104 smaller than the size of the studs 24.

In the first aspect of the present invention:

the magazine 80 at the position of the stopping member 104 may be a cylinder having the outer wall (the magazine outer wall 112) and the inner wall (the magazine inner wall 114);

the cylinder may include the plurality of magazine through holes 116 that penetrate from the outer wall (the magazine outer wall 112) to the inner wall (the magazine inner wall 114), and that are disposed alongside one another along the circumferential direction of the cross section of the stopping member 104 perpendicular to the direction (the X direction) in which the studs are supplied;

the movable bodies may be the balls 122 that are capable of moving inside the magazine through holes 116;

the locking member may include the reciprocating member 124 which surrounds the outer wall (the magazine outer wall 112) of the cylinder, which covers the opening (the outer wall opening 120) of each of the magazine through holes 116 on the side of the outer wall, and which is capable of moving reciprocally along the axial line of the stopping member 104;

the reciprocating member 124 may include the large diameter portion 130 and the small diameter portion 132 on the inner circumferential surface 126 facing the outer wall (the magazine outer wall 112) of the cylinder;

the opening (the inner wall opening 118) of each of the magazine through holes 116 on the side of the inner wall may have a size or a shape configured to allow a portion of each of the balls 122 to protrude into the interior of the stopping member 104; and

in the case that the position to which the reciprocating member 124 moves is a position where the large diameter portion 130 faces directly in front of the magazine through holes 116, the balls 122 may be capable of moving between the large diameter portion 130 and the magazine through holes 116, whereas in the case that the position to which the reciprocating member 124 moves is a position where the small diameter portion 132 faces directly in front of the magazine through holes 116, the movement of the balls 122 may be restricted by the reciprocating member 124 in a state in which a portion of each of the balls 122 protrudes from the opening of each of the magazine through holes 116 on the side of the inner wall into the interior of the stopping member 104.

In the first aspect of the present invention:

the switching mechanism 82 may be the first switching mechanism 82a;

the air injection unit may be the first air injection unit 90;

the studs 24 may each include the small diameter stud portion (the shaft portion 26) positioned on the distal end side thereof, and the large diameter stud portion (the flange 28) positioned on the proximal end side thereof;

the magazine 80 may be capable of stopping the studs 24 in at least one standby section (the first standby section 106, the second standby section 108) which is positioned in the magazine hole 98 farther on the one end side than the stopping member 104;

and there may further be provided:

the second switching mechanism 82b, which has the same structure as the first switching mechanism 82a, and which switches between the state in which the studs 24 are stopped at the standby section (the first standby section 106, the second standby section 108), and a state in which the studs 24 are allowed to pass; and

the second air injection unit 92 which is disposed at the one end of the magazine hole 98, and which injects the air from the one end side to the studs 24 that are stopped at the standby section (the first standby section 106, the second standby section 108) with the large diameter stud portions oriented toward the one end side.

In accordance with the above-described configuration, stopping and passage of the first stud 24a in the stopping member 104 and the stopping and advancing of the second stud 24b in the standby section (the first standby section 106, the second standby section 108) can be individually controlled.

In the first aspect of the present invention:

as the standby section, there may be provided the first standby section 106 positioned on the other end side, and the second standby section 108 positioned farther on the one end side than the first standby section 106;

the interval between the first standby section 106 and the second standby section 108 may be shorter in length than the studs 24; and

when one of the studs 24 comes into contact with the movable bodies (the balls 122) disposed in the first standby section 106 and is stopped, the stud 24 arranged next to this stud 24 may be stopped by coming into contact with this stud 24 stopped at the first standby section 106, without coming into contact with the movable bodies (the balls 122) disposed in the second standby section 108.

In the first aspect of the present invention:

the studs 24 may be flanged studs each including a shaft portion 26 and a flange 28 formed at a proximal end of the shaft portion 26; and

the plurality of movable bodies (the balls 122) may cause the studs 24 to stop by coming into contact with the surface of the flanges 28 on the distal end side.

The second aspect of the present invention is characterized by the stud supplying method that uses the stud supplying device 22 according to the first aspect to supply the studs 24 to the welding electrode (the second electrodes 38) of the projection welding device 12, the stud supplying method comprising the steps of:

accommodating the first stud 24a and the second stud 24b in this order in the magazine hole 98;

placing the movable bodies (the balls 122) of the first switching mechanism 82a in contact with the first stud 24a and thereby stopping the first stud 24a at the stopping member 104;

ejecting the first stud 24a by switching a state of the first switching mechanism 82a, while injecting the air from the first air injection unit 90 to correct the posture of the first stud 24a that is stopped at the stopping member 104;

placing the movable bodies (the balls 122) of the second switching mechanism 82b in contact with the second stud 24b and thereby stopping the second stud 24b at the standby section (the first standby section 106); and

after having ejected the first stud 24a, allowing the second stud 24b to move to the stopping member 104 by switching a state of the second switching mechanism 82b while injecting air from the second air injection unit 92.

The stud supplying device and the stud supplying method according to the present invention are not limited to the embodiments described above, and it is a matter of course that various modified or additional configurations could be adopted therein without departing from the essence and gist of the present invention.

What is claim is:

1. A stud supplying device that supplies studs to be welded onto a workpiece to a welding electrode of a projection welding device, the stud supplying device comprising:
a magazine including a magazine hole penetrating therethrough in a direction in which the studs are supplied to the welding electrode, wherein the studs are allowed to be inserted from one end and ejected from another end of the magazine hole, the studs are allowed to be stopped at a stopping member positioned on a side of the other end of the magazine hole, and a predetermined number of the studs are allowed to be accommodated inside the magazine hole in series and in alignment from the stopping member toward a side of the one end;
a switching mechanism including a plurality of movable bodies configured to move between a position in which the movable bodies come into contact with the studs and a position in which the movable bodies do not come into contact with the studs, and a locking member configured to restrict movement of the plurality of movable bodies, the switching mechanism being configured to switch between a state in which the studs are stopped at the stopping member and a state in which the studs are allowed to pass; and
an air injection unit disposed farther on the side of the one end than the stopping member, and configured to inject air from the side of the one end to the studs that are stopped at the stopping member.

2. The stud supplying device according to claim 1, wherein:
the plurality of movable bodies are arranged alongside one another in a circumferential direction of a cross section of the stopping member, are configured to move toward an interior of the stopping member and make a size of the stopping member smaller than a size of the studs to cause the studs to stop, and are configured to move toward an outer side of the stopping member and make the size of the stopping member greater than the size of the studs to allow the studs to pass; and
the locking member restricts movement of the plurality of movable bodies in a state in which the plurality of movable bodies have made the size of the stopping member smaller than the size of the studs.

3. The stud supplying device according to claim 2, wherein:
the magazine at a position of the stopping member is a cylinder having an outer wall and an inner wall;
the cylinder includes a plurality of magazine through holes that penetrate from the outer wall to the inner wall, and that are disposed alongside one another along the circumferential direction of the cross section of the stopping member perpendicular to the direction in which the studs are supplied;
the movable bodies are balls configured to move inside the magazine through holes;
the locking member includes a reciprocating member configured to surround the outer wall of the cylinder, cover an opening of each of the magazine through holes on a side of the outer wall, and move reciprocally along an axial line of the stopping member;
the reciprocating member includes a large diameter portion and a small diameter portion on an inner circumferential surface facing the outer wall of the cylinder;
an opening of each of the magazine through holes on a side of the inner wall has a size or a shape configured to allow a portion of each of the balls to protrude into the interior of the stopping member; and
in a case that a position to which the reciprocating member moves is a position where the large diameter portion faces directly in front of the magazine through holes, the balls are allowed to move between the large diameter portion and the magazine through holes, whereas in a case that the position to which the reciprocating member moves is a position where the small diameter portion faces directly in front of the magazine through holes, movement of the balls is restricted by the reciprocating member, in a state in which a portion of each of the balls protrudes from the opening of each of the magazine through holes on the side of the inner wall into the interior of the stopping member.

4. The stud supplying device according to claim 1, wherein:
the switching mechanism is a first switching mechanism;
the air injection unit is a first air injection unit;
the studs each include a small diameter stud portion positioned on a distal end side thereof, and a large diameter stud portion positioned on a proximal end side thereof;
the magazine is configured to stop the studs in at least one standby section which is positioned in the magazine hole farther on the side of the one end than the stopping member; and
the stud supplying device further comprises:
a second switching mechanism having a same structure as the first switching mechanism, and configured to switch between a state in which the studs are stopped at the standby section and a state in which the studs are allowed to pass; and
a second air injection unit disposed at the one end of the magazine hole, and configured to inject air from the side of the one end to the studs that are stopped at the standby section with the large diameter stud portions oriented toward the side of the one end.

5. The stud supplying device according to claim 4, wherein:
a first standby section positioned on the side of the other end, and a second standby section positioned farther on the side of the one end than the first standby section, are provided as the standby section;
an interval between the first standby section and the second standby section is shorter in length than the studs; and
when one of the studs comes into contact with the movable bodies disposed in the first standby section and is stopped, the stud arranged next to this stud is stopped by coming into contact with this stud stopped at the first standby section, without coming into contact with the movable bodies disposed in the second standby section.

6. The stud supplying device according to claim 1, wherein:
the studs are flanged studs each including a shaft portion and a flange formed at a proximal end of the shaft portion; and
the plurality of movable bodies cause the studs to stop by coming into contact with surfaces of the flanges on a distal end side.

7. A stud supplying method for supplying studs to be welded onto a workpiece, to a welding electrode of a projection welding device by using a stud supplying device that supplies the studs to the welding electrode of the projection welding device,
the stud supplying device including:
a magazine including a magazine hole penetrating therethrough in a direction in which the studs are supplied to the welding electrode, wherein the studs are allowed to be inserted from one end and ejected from another end of the magazine hole, the studs are allowed to be stopped at a stopping member positioned on a side of the other end of the magazine hole, and a predetermined number of the studs are allowed to be accommodated inside the magazine hole in series and in alignment from the stopping member toward a side of the one end;
a switching mechanism including a plurality of movable bodies configured to move between a position in which the movable bodies come into contact with the studs and a position in which the movable bodies do not come into contact with the studs, and a locking member configured to restrict movement of the plurality of movable bodies, the switching mechanism being configured to switch between a state in which the studs are stopped at the stopping member and a state in which the studs are allowed to pass; and
an air injection unit disposed farther on the side of the one end than the stopping member, and configured to inject air from the side of the one end to the studs that are stopped at the stopping member, wherein
the switching mechanism is a first switching mechanism,
the air injection unit is a first air injection unit,
the studs each include a small diameter stud portion positioned on a distal end side thereof, and a large diameter stud portion positioned on a proximal end side thereof,
the magazine is configured to stop the studs in at least one standby section which is positioned in the magazine hole farther on the side of the one end than the stopping member, and
the stud supplying device further includes:
a second switching mechanism having a same structure as the first switching mechanism, and configured to switch between a state in which the studs are stopped at the standby section and a state in which the studs are allowed to pass; and
a second air injection unit disposed at the one end of the magazine hole, and configured to inject air from the side of the one end to the studs that are stopped at the standby section with the large diameter stud portions oriented toward the side of the one end,
the stud supplying method comprising the steps of:
accommodating a first stud and a second stud in this order in the magazine hole;
placing the movable bodies of the first switching mechanism in contact with the first stud and thereby stopping the first stud at the stopping member;
ejecting the first stud by switching a state of the first switching mechanism, while injecting air from the first air injection unit to correct a posture of the first stud that is stopped at the stopping member;
placing the movable bodies of the second switching mechanism in contact with the second stud and thereby stopping the second stud at the standby section; and
after having ejected the first stud, allowing the second stud to move to the stopping member by switching a state of the second switching mechanism while injecting air from the second air injection unit.
